(19) United States
(12) Patent Application Publication
(10) Pub. No.: US 2012/0291531 A1
(43) Pub. Date: Nov. 22, 2012

(54) LIQUID CHROMATOGRAPH AND LIQUID FEEDER FOR LIQUID CHROMATOGRAPH

(76) Inventors: Daisuke Akieda, Hitachinaka (JP); Tomohiro Shoji, Hitachinaka (JP)

(21) Appl. No.: 13/575,191

(22) PCT Filed: Jan. 25, 2012
(86) PCT No.: PCT/JP2011/051194

§ 371 Date: Jul. 25, 2012

(30) Foreign Application Priority Data
Jan. 25, 2010 (JP) 2010-012735

(51) Int. Cl. G01N 30/16

(52) U.S. Cl. 73/61.55

(57) ABSTRACT

Provided is a liquid chromatograph of a gradient type capable of promoting the mixture of a plurality of solvents without increasing flow passage volume. To this end, the liquid chromatograph includes: a Pump configured to suck a plurality of solvents and feed the solvents to a sample injection device, a separation column that separates a sample to be analyzed into components; and a detector that detects a component of the sample fed from the separation column. The Pump is configured to suck the plurality of solvents through an intake port and feed the solvents to a sample injection device through a discharge port and mix the plurality of solvents at between the intake port and the discharge port. The Pump further includes a cylinder and a plunger that reciprocates inside the cylinder, and the cylinder has an inner wall provided with a recess to generate a whirl in the plurality of solvents.

### TECHNICAL FIELD

The present invention relates to a liquid feeder used for a liquid chromatograph.

### BACKGROUND ART

Liquid chromatographs are analyzers configured to add a sample to be analyzed to solvent fed by a Pump, separate the sample into components by a separation column and detect each component fed at different timing by a detector such as a spectrometer to specify components of the sample. One known example of the Pump is in a mode such that solvent is fed using a plunger that reciprocates within a cylinder.

For some samples to be analyzed, a gradient method is used, feeding liquid using a plurality of solvents while changing the density (see Patent Document 1, for example). Such a liquid-feeding system is configured to feed liquid while changing the mixture ratio of the plurality of solvents, thus improving the Resolution of a sample to be analyzed at a separation column and so shortening the analysis time. In a gradient liquid-feeding system, repeatability of measurement data of a sample to be analyzed is dependent on the mix performance of solvents. When eluent hard to mix is used, repeatability of the measurement data may deteriorate. In order to improve the repeatability of measurement data, an attempt is made to use a mixer to mix solvents so as to improve the mix performance (see Patent Document 2, for example)

### Patent Document 1: JP Patent Publication (Kokai) No. 2004-271409 A

### Patent Document 2: JP Patent Publication (Kokai) No. 09-325141 A (1997)

### DISCLOSURE OF THE INVENTION

### Problem to be Solved by the Invention

The attempt to connect a mixer for an improved mix performance of solvents in a liquid chromatograph of a gradient type, however, increases a flow passage volume due to the volume of the mixer, thus lengthening the analysis time. Especially in the case of a gradient system called a low-pressure gradient type having a feature of mixing solvents prior to a pump to feed solvent, the mixer connected will lengthen the analysis time because the volume in a cylinder is included in the flow passage volume.

It is an object of the present invention to provide a liquid chromatograph of a gradient type capable of promoting the mixture of solvents without increasing flow passage volume.

### Means for Solving the Problem

In order to solve the aforementioned problem, according to one embodiment of the present invention, a liquid chromatograph is configured to add a sample to be analyzed to the mixture of a plurality of solvents and detect a component separated by a separation column to analyze the components of the sample. The liquid chromatograph includes a control unit to control the open/close of valves provided to change the mixture ratio of the plurality of solvents and a Pump configured to suck the mixed plurality of solvents and discharge the solvents for feeding. The Pump includes a configuration in a cylinder for sucking and discharging the mixed plurality of solvents so as to generate a flow to promote the mixture of the solvents.

### Effects of the Invention

According to the present invention, a liquid chromatograph of a gradient type is provided, capable of promoting the mixture of solvents without increasing flow passage volume.

### BRIEF DESCRIPTION OF THE DRAWINGS

FIG. 1 illustrates the configuration of a liquid chromatograph of a low-pressure gradient type.

FIG. 2 is a vertical sectional view illustrating the configuration of a Pump.

FIG. 3 is a vertical sectional view illustrating the configuration of a cylinder of FIG. 2.

FIG. 4 is a vertical sectional view illustrating the configuration of a Pump.

FIG. 5 is a vertical sectional view illustrating the configuration of a Pump.

FIG. 6 is a vertical sectional view illustrating the configuration of a Pump.

### BEST MODE FOR CARRYING OUT THE INVENTION

The following describes embodiments of the present invention, with reference to the drawings. Note here that the present invention is not limited to the below-described embodiments, and may include various modification examples. For instance, the entire detailed configuration of the embodiments described below for explanatory convenience is not always necessary for the present invention. A part of one embodiment may be replaced with the configuration of another embodiment, or the configuration of one embodiment may be combined with the configuration of another embodiment. The configuration of each embodiment may additionally include another configuration, or a part of the configuration may be deleted or replaced.

### Embodiments

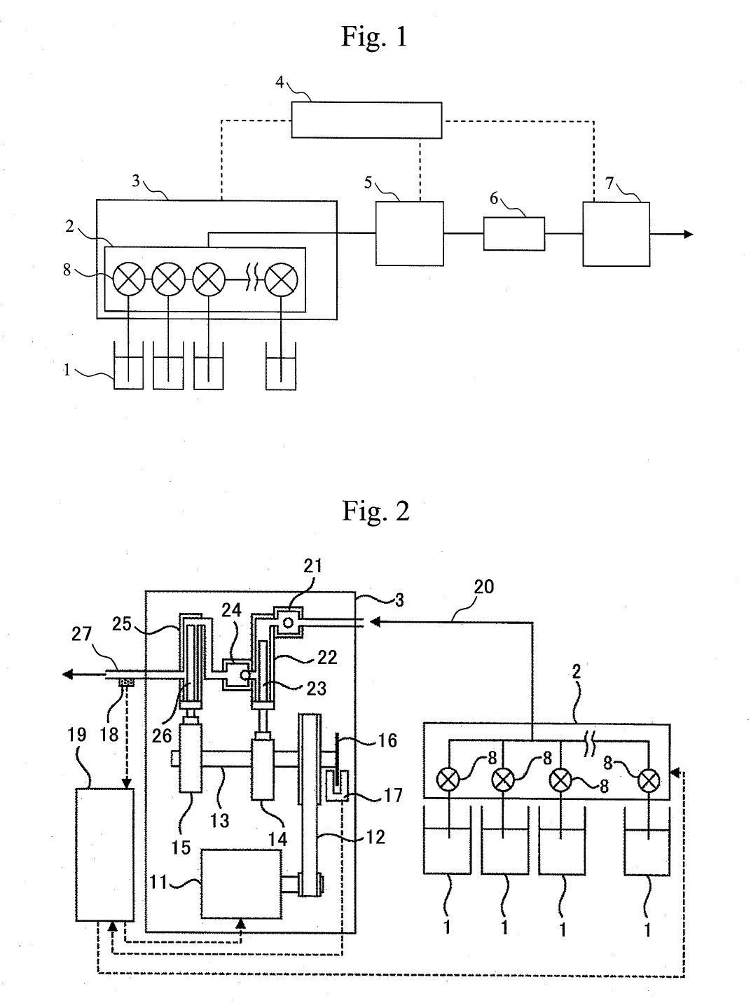

FIG. 1 illustrates the configuration of a liquid chromatograph of a low-pressure gradient type using a plurality of solvents to feed a sample to be analyzed. A plurality of types of solvents contained in a plurality of containers 1 are selected by a switching device 2 including a plurality of switching valves 8, and are sucked by a Pump 3 for feeding. The switching device 2 is capable of selecting any solvent from a plurality of solvents in the containers 1 and changing the degree of opening of the switching valves 8 over time so as to change the mixture ratio of the plurality of solvents gradually. A sample injector 5 injects a sample to be measured to solvent fed by the Pump 3, a separation column 6 separates the sample to be measured into components, and each component is fed to a detector 7 at different timing for detection.

A controller 4 controls the flow amount of liquid fed by the Pump 3, the degree of opening of the switching valves 8, timing of sample injection by the sample injector 5, issuance of an operation signal of the detector 7 and the reception of detection data.

FIG. 2 is a vertical sectional view illustrating the configuration of the Pump 3 of FIG. 1, showing the configuration of a plunger pump, in which a plunger reciprocates within a cylinder to feed liquid. The rotary motion of a motor 11 is transmitted to a cam shaft 13 via a belt 12 so that a first plunger 23 reciprocates via a cam 14 and a second plunger 26 reciprocates via a cam 15. The number of revolutions of the cam shaft 13 is detected by a rotation sensor. For instance, a disc 16 having a slit therein may be provided at the cam shaft 13 and a sensor 17 of an optical type, a capacitive type, a magnetic line type or the like may detect the slit of the disc 16, whereby the number of revolutions of the cam shaft 13 can be detected.

The flow amount of solvent in the containers 1 can be adjusted by the open/close timing and the degree of opening of the switching valves 8. In order to suck the solvents in the containers 1 to the Pump 3 via an intake passage 20, a check valve 21 is firstly opened so that the first plunger 23 in a first cylinder 22 moves downward of the drawing to start a suction operation of the solvents. When the first cylinder 22 becomes full of the solvents, the first plunger 23 moves upward of the drawing to start a pushing operation. At this time while the check valve 21 is closed, a check valve 24 is opened, and the second plunger 26 in a second cylinder 25 performs a suction operation in synchronization with the pushing operation of the first plunger 23 so that the second cylinder 25 is filled with the solvents. Next, when the second plunger 26 starts a pushing operation, the check valve 24 is closed so that the solvent in the second cylinder 25 is fed to the sample injector 5 of FIG. 1 via a discharge passage 27.

The discharge passage 27 downstream of the second cylinder 25 includes piping provided with a pressure sensor 18 to measure the pressure in the piping, and a value of the pressure in the piping measured by the pressure sensor 18 is sent to a Pump control unit 19. The revolutions of the cam shaft 13 measured by the above-mentioned sensor 17 also is sent to the Pump control unit 19. On the basis of these two values, the Pump control unit 19 controls the revolutions of the motor 11. In a gradient system configured to gradually change the mixture ratio of a plurality of solvents over time, the Pump control unit 19 further controls the open/close timing and the degree of opening of the switching valves 8 corresponding to target solvents.

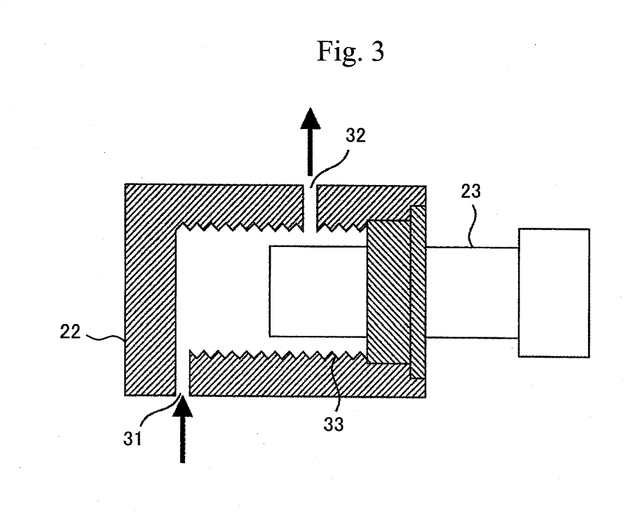

FIG. 3 is a vertical sectional view illustrating the configuration of the first cylinder 22 of FIG. 2. The reciprocation operation of the first plunger 23 causes solvent to be sucked through an inlet 31 and discharged through an outlet 32. The first cylinder 22 has an inner wall provided with an uneven part 33 such as a groove having the effect of promoting the mixture of a plurality of solvents during suction and discharge of the solvents. The uneven part 33 may have a shape such as dimples, from which a large effect can be expected. Another shape of the uneven part 33 may be a spiral groove, for example, facilitating the processing during fabrication. The second cylinder 25 may be configured similarly for promotion of the mixture of solvents.

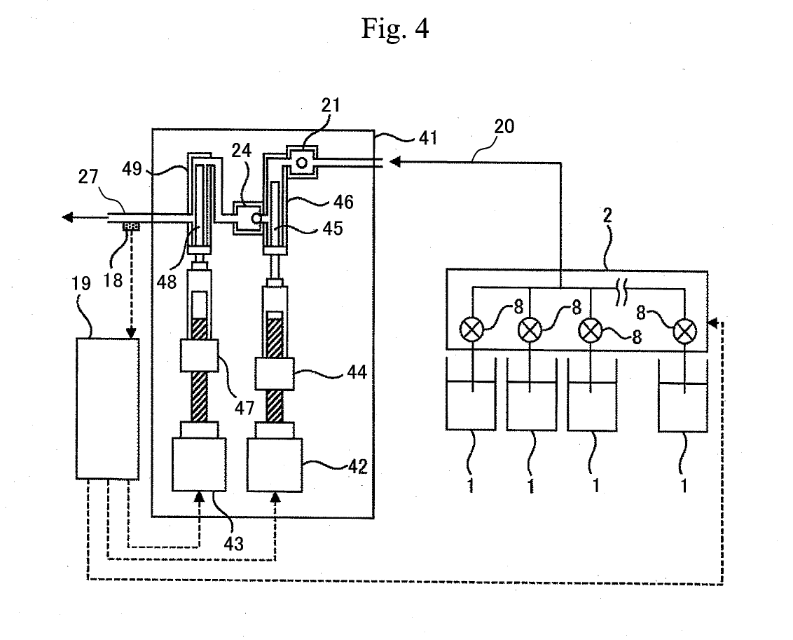

Similarly to FIG. 2, FIG. 4 is a vertical sectional view illustrating the configuration of a Pump, showing an example where a Pump 41 uses a plunger pump to drive a plunger without using a cam. Since no cam is used, reciprocation operations of a first plunger and a second plunger can be controlled independently. Further the stroke of each plunger can be made different.

The rotary motion of a motor 42 moves a first plunger 45 linearly in a first cylinder 46 via a ball screw mechanism 44. As the revolutions of the motor 42 changes, the speed of the linear movement of the first plunger 45 changes, and as the rotation direction of the motor 42 is reversed, the linear movement direction of the first plunger 45 changes in the reverse direction.

The same goes for a second plunger 48, and the rotary motion of a motor 43 moves the second plunger 48 linearly in a second cylinder 49 via a ball screw mechanism 47. As the revolutions of a motor 43 changes, the speed of the linear movement of the second plunger 48 changes, and as the rotation direction of the motor 43 is reversed, the linear movement direction of the second plunger 48 changes in reverse direction.

In the case where a plurality of solvents having different properties such as viscosity is gradient-mixed, this mechanism allows the strokes and the speeds of the plungers to be set suitable for a mixture ratio including a large-viscosity solvent much or for a mixture ratio including a small-viscosity solvent much.

Similarly to FIG. 3, the first cylinder 46 and the second cylinder 49 in the plunger pump illustrated in FIG. 4 also may have an inner face provided with an uneven part 33 for further promotion of the mixture of solvents.

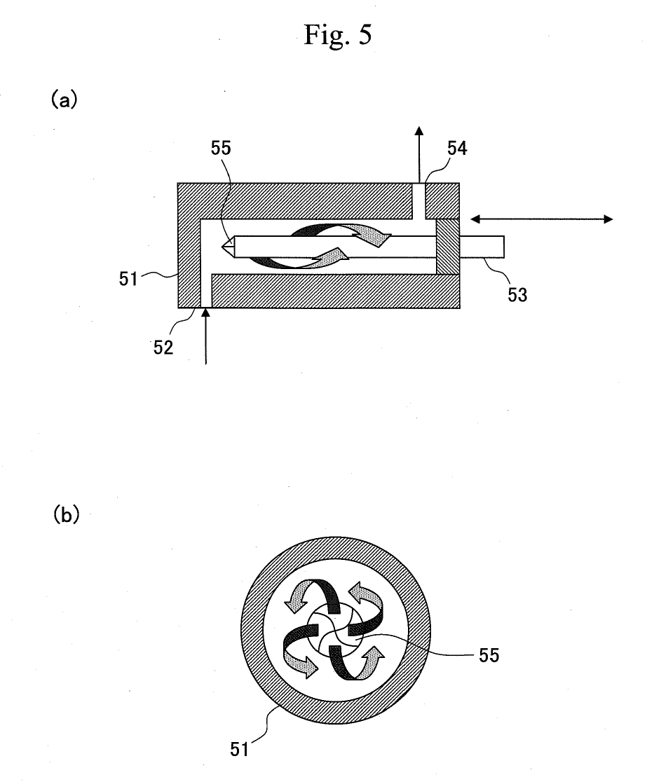

Similarly to FIG. 3, FIG. 5 is a vertical sectional view illustrating the configuration of a cylinder 51. A plunger 53 may be provided with a plurality of recesses 55 at a tip end thereof so as to generate whirls as illustrated in arrows in FIG. 5B. In the case of FIG. 5B, at the tip end of the plunger 53 are provided four recesses 55. These four recesses 55 each include a slope that is the highest at the center axis of the plunger 53 and is lowered toward the outer radius direction. The slopes of these four recesses 55 have the same twisting direction viewed from the tip end of the plunger 53. As illustrated in FIG. 5A, when the plunger 53 moves from right to left of the drawing, a plurality of solvents sucked through an inlet 52 is pushed by the recesses 55, and generates whirls as illustrated in the arrows. Accordingly, as the plurality of solvents sucked through the inlet 52 flows along the plunger 53, the mixture of the plurality of solvents is promoted and the solvents are finally discharged through an outlet 54.

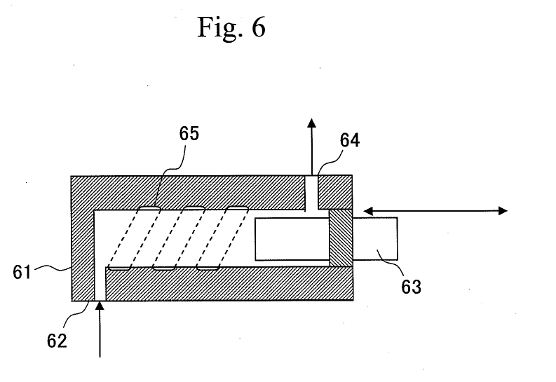

Similarly to FIG. 3, FIG. 6 is a sectional view illustrating the configuration of a cylinder 61. In the case of FIG. 6, the cylinder 61 has an inner periphery face provided with a recess 65 that is wide and extends in a spiral manner in the axis direction. When the plunger 63 moves right to left of the drawing, such a recess 65 causes a plurality of solvents sucked through an inlet 62 to flow along the recess 65 while being pushed by the plunger 63. At this time, whirls are generated in the plurality of solvents, whereby the plurality of solvents flows to an outlet 64 while the mixture of the solvents is promoted. Finally, the mixed plurality of solvents is discharged through the outlet 64.

As stated above, according to embodiments of the present invention, there is no need to add a special device to mix solvents to a liquid chromatograph of a gradient type configured to mix a plurality of solvents. Therefore, the mixture of the solvents can be promoted in a plunger pump without increasing the flow passage volume, and so an improved liquid chromatograph of a gradient type can be provided.

### DESCRIPTION OF REFERENCE NUMBERS

1: Containers

2: Switching device

3: Pump

4: Controller

8: Switching valves

22: First cylinder

23: First plunger

25: Second cylinder

26: Second plunger

33: Uneven part

45: First plunger

46: First cylinder

48: Second plunger

49: Second cylinder

51: Cylinder

53: Plunger

55: Recesses

61: Cylinder

63: Plunger

65: Recess

1. A liquid chromatograph, comprising:
a sample injection device that injects a sample to be analyzed to a plurality of mixed solvents;
a separation column that separates the sample to be analyzed in the solvents fed from the sample injection device into components; and
a detector that detects a component of the sample to be analyzed separated by the separation column, further comprising:
a Pump configured to suck the plurality of solvents through an intake port and feed the solvents to the sample injection device through a discharge port and mix the plurality of solvents at between the intake port and the discharge port.

2. The liquid chromatograph according to claim 1, wherein the Pump includes a cylinder provided between the intake port and the discharge port, and a plunger that reciprocates inside the cylinder, and the cylinder has an inner wall provided with a recess.

3. The liquid chromatograph according to claim 2, wherein the recess provided at the inner wall of the cylinder is a spiral-form groove.

4. The liquid chromatograph according to claim 1, wherein the Pump includes a cylinder provided between the intake port and the discharge port, and a plunger that reciprocates inside the cylinder, and the plunger includes, at a tip end thereof, a recess to generate a whirl in the solvents.

5. A Pump for liquid chromatograph used for a liquid chromatograph including: a sample injection device that injects a sample to be analyzed to a plurality of mixed solvents; a separation column that separates the sample to be analyzed in the solvents fed from the sample injection device into components; and a detector that detects a component of the sample to be analyzed separated by the separation column, the Pump comprising:
an intake port through which the plurality of solvents is sucked, and a discharge port through which the solvents are fed to the sample injection device,
wherein the plurality of solvents is mixed at between the intake port and the discharge port.

6. The Pump for liquid chromatograph according to claim 5, further comprising: a cylinder provided between the intake port and the discharge port, and a plunger that reciprocates inside the cylinder, the cylinder having an inner wall provided with a recess.

7. The Pump for liquid chromatograph according to claim 6, wherein the recess provided at the inner wall of the cylinder is a spiral-form groove.

8. The Pump for liquid chromatograph according to claim 5, further comprising: a cylinder provided between the intake port and the discharge port, and a plunger that reciprocates inside the cylinder, the plunger including, at a tip end thereof, a recess to generate a whirl in the solvents.
